(19) United States
(12) Patent Application Publication
(10) Pub. No.: US 2002/0138635 A1
(43) Pub. Date: Sep. 26, 2002

(54) Multi-ISP controlled access to IP networks, based on third-party operated untrusted access stations

(75) Inventors: Jens-Peter Redlich, Plainsboro, NJ (US); Thomas Kuehnel, Princeton, NJ (US); Wolf Mueller, Berlin (DE)

Correspondence Address: SUGHRUE MION, PLLC, 2100 Pennsylvania Avenue NW, Washington, DC, 20037-3213, US

(73) Assignee: NEC USA, INC.

(21) Appl. No.: 10/057,914

(22) Filed: Jan. 29, 2002

Related U.S. Application Data
(60) Provisional application No. 60/278,436, filed on Mar. 26, 2001.

(51) Int. Cl. G06F 15/16; H04L 9/32; G06F 11/30; G06F 12/14; H04L 9/00

(52) U.S. Cl. 709/229; 713/200

(57) ABSTRACT

A mechanism that allows sharing of an existing infrastructure for access to public or private IP networks, such as the public Internet or private LANs is provided. Specifically, infrastructure owners lease the infrastructure resources on a short-term basis to different Internet Service Providers (ISPs). An ISP uses these resources to provide Internet services to subscribing customers or users. The ISP controls all aspects of the Internet service provided to the subscriber, including billing, bandwidth management, and e-mail. The ISP also ensures privacy for the subscriber by means of encryption. Leasing network resources from an existing network infrastructure frees the ISP from building an expensive access infrastructure itself while the infrastructure owner is given an opportunity to generate additional revenue from infrastructure. Importantly, neither the user, nor the ISP need to trust the access station (i.e.: the access station is untrusted) through which the access to the IP network is accomplished.

### CROSS-REFERENCE TO RELATED APPLICATIONS

This application claims the benefit of U.S. Provisional Application No. 60/278,436, filed Mar. 26, 2001. Application No. 60/278,436 is incorporated herein by reference in its entirety.

### BACKGROUND READING

The documents identified below provide useful background reading on wireless technology. The below-cited documents are incorporated by reference in their entirety for their useful background information as indicated in the remainder of this description.

1.) Bruce Schneier, “Applied Cryptography: Protocols, Algorithms, and Source Code in C,” 2^{nd} Edition, John Wiley & Sons, 1995, ISBN 047117099;

2.) R. Droms, “Dynamic Host Configuration Protocol (DHCP), IETF RCF2131, 1997; and

3.) Egevang, K. and Francis, P, “The IP Network Address Translator (NAT), ETF RFC 1631, 1994.

### Field of the Invention

The present invention relates to a system and method of providing public access to an IP network, such as the public Internet, a corporate intranet, or a private LAN, using third-party operated access stations, where neither the user, nor this user's ISP, trust the correct operation of the access station, thus rendering the access station an “untrusted” access station. More specifically, the present invention relates to a method of performing authentication, authorization, accounting, and ciphering of data for access to an IP network via access stations that are operated by a potentially malicious and therefore untrusted third-party. The disclosed method and system can be used in conjunction with wireless and wireline access alike, where “wireless” may be short-range technology that operates in unlicensed frequency bands, as well as larger range licensed radio technology.

### Background of the Prior Art

In the prior art public access to IP networks, such as the Internet, is provided via an Internet Service Provider (ISP), which also owns or leases the transmission facilities like modems. In most cases a user wanting to access the Internet has to have a service agreement with the ISP in a given location area. To extend their reach to traveling subscribers, some ISPs signed roaming agreements that govern the procedures for authentication, authorization and accounting. Similar procedures are in place for cellular operators allowing subscribers of a given operator to move into the coverage area of another operator. However, the established procedures assume that the network access is trusted. This assumption was warranted due to the private access mechanism like dial-up modem banks, the high costs of infrastructure and the exclusive ownership of frequency spectrum in case of cellular operators.

The advent of a second prior art technology, enabling wireless access to IP networks using cheap infrastructure that is operated in unlicensed frequency spectrum, facilitates the creation of small independent access providers. Since the range of those wireless access technologies based on Wireless Local Area Networks (WLANs) and Personal Area Networks (PANs) is small, the operation of infrastructure for public Internet access in a given estate is governed by the owner of the estate. In fact, any apartment or house owner having high speed Internet access via cable or DSL can offer access to surrounding neighbors by operating a WLAN access point. The access to those wireless access points, however, is limited to devices of the same organization or household. Providing access to foreign IP devices (such as visitors who bring their own, WLAN-card equipped, or neighbors who have PCs equipped with a WLAN card) is not secure, usually not allowed or even technically impossible. Moreover, privately held access stations are usually tied to their owner's ISP, i.e. a guest subscribed to a different ISP cannot obtain services that are provided by his own ISP, and can not be billed by his own ISP for the Internet access.

Applying the mechanisms to enable public access as they are described herein as the first prior art to small independent operators that offer Internet access in a small geographical area as described herein as second prior art has various problems and disadvantages. For example, the roaming user does not know the trustworthiness of the operator of the WLAN. Malicious operators may find it easy to eavesdrop on the communication between the user and a content provider. They might also find means to obtain credentials like login names and passwords from the user's traffic. In addition, prior-art authentication and authorization procedures do not facilitate usage based accounting, which may be needed for re-imbursement of the independent operator for access provided to roaming users.

Today, privately owned access stations are ubiquitously available, providing users everywhere with a potential means of accessing the Internet. However, nowadays ISPs have to build their own access infrastructure, which is costly and often inflexible in terms of supporting temporary users.

### SUMMARY OF THE INVENTION

This invention relates to an access station to IP networks. More particularly, this invention relates to an access station to IP networks that is owned and operated by a party other than the user of its service and this user's ISP. This invention relates, even more particularly, to an apparatus that can provide computers and other IP-based devices with access to IP networks, such as, for example, the Internet or a corporate Intranet, where the access station obtains the user identification as well as the user's ISP identification from the IP devices that desire service, where the access station informs the user's ISP about the user's desire to obtain service, where the user's ISP dynamically obtains control of resources inside the access apparatus in order to provide the user with the services he subscribed for. Finally, the ISP arranges for payment of the access station for usage of its resources, and arranges billing of the user (its subscriber).

The present invention includes an end-user who subscribed to Internet services at an Internet service provider, an access node or infrastructure owner, and a trusted gateway to the Internet and a method for anonymous Internet access provision to a subscriber of an Internet service via a third party owned access node. More specifically, the present invention includes procedures for mutual authentication of subscriber and Internet service provider, and the key distribution needed for the establishment of a secure tunnel between the end-user and a trusted gateway to the Internet, comprising the steps of service request, Internet service provider authentication, subscriber authentication, generation of a unique session key, distribution of the session key to trusted network node and subscriber, and the data transfer using the secure tunnel that is established between subscriber and the trusted network element via the third party access node using the previously distributed session key.

The method further comprises the steps of distributing timeout values from the Internet service provider to the subscriber, the access node and said trusted network element, wherein the timeout values triggers a re-authentication procedure between the said subscriber and Internet service provider.

Additionally, the method comprises the steps of releasing the tunnels in case one of the timers that is associated with the tunnel, located at the subscriber and the trusted network element and another timer being located at the said access node, expires.

Additionally, a method for generates accounting information based on the number of successful authentications is further provided. A method for providing prepaid service using accounting information and to determine the remaining time before a re-authentication is also required.

The application of this invention includes, but is not limited to the following cases:

Access stations in private households provide WLAN (IEEE 802.11), BlueTooth (IEEE 802.15), or HiperLan-based wireless access to visitors or neighbors;

Hotels/Airports own and operate access stations (WLAN, BlueTooth, HiperLan) in order to provide their customers with Internet access that is controlled by the customer's ISP; and

Conferences lease and temporarily deploy access stations (WLAN, BlueTooth, HiperLan) at conference venues, in order to give conference attendees Internet access that is controlled by the conference attendee's ISP.

An object of the invention is to provide a secure method for provisioning of Internet access by an Internet service provider to its subscribers via third party owned untrusted access nodes.

Yet another object of the invention is to provide accounting information between the Internet service provider and the access node owner, as well as the Internet service provider and the subscriber, wherein the accounting information is derived as integral part of the operation of the system and protected from malicious manipulations.

It is understood that, throughout the entire document, the term “Internet” means “IP-based network” in its broadest sense, including, but not limited to, the Public Internet, Corporate Intranet, private or public LANs, and IP-based ad-hoc networks.

### BRIEF DESCRIPTION OF THE DRAWINGS

The accompanying drawings, which are included to provide a further understanding of preferred embodiments of the present invention are incorporated in and constitute a part of this specification.

FIG. 1 illustrates a model of the network according to the present invention;

FIG. 2 illustrates the information flow between components of an embodiment of the present invention;

FIG. 3 shows the tunneled data packet that is transferred from the user (U) to the trusted network element T via the access station A;

FIG. 4 depicts the message sequence for authentication and distribution of session keys; and

FIG. 5 shows the message sequence for association and data transfer.

### DETAILED DESCRIPTION

The detailed description is organized as follows: in the section entitled “Component Overview” the system components are introduced and a description of the components relation to one another is provided. In the section entitled “Operation of the Invention,” different embodiments of the present invention and its applications are addressed. Furthermore, in order to facilitate understanding and clarity, the description of the invention is broken down into the following sections including: “Mutual Authentication of U and P”, “Creation of a Secure Tunnel Between U and T via A,” “Data Transfer Between U and the Internet,” Tunnel Release and Timeout,” Accounting Procedures.”

### Components Overview

It is important to note that the term “IP network” is used to represent all possible IP-based infrastructure networks, including the public Internet and corporate intranets.

User's Terminal device (U)

U refers to a user's IP-based terminal device. This may be any mobile or stationary device that uses the Internet Protocol suite (IP) to communicate with other devices, including but not limited to a workstation computer, personal computer (PC), laptop computer, handheld PC, telephone or any other IP-based device or appliance. It is however anticipated, that in most cases this terminal device will be small and mobile, and that it will have either a wire-based or a wireless means to connect to the IP network, or both (see Access Station below). It may further be assumed that at any given moment this device is associated with at most one user, i.e. it can be perceived as “this user's device”.

Access Station (A)

A refers to an access station. An access station is used to connect a terminal device U to an IP-based infrastructure network, e.g. Intranet or Internet. It receives traffic from the IP network and delivers it to the correct terminal U, and, it receives traffic from terminals U and forwards it to the IP network. The means of communication between A and U may be wire-based or wire-less; our invention applies to both cases. It is further assumed that A has an owner and an operator, as well as an owner of the operating privileges, as it is for instance the case for radio base stations that require permission to use a certain frequency spectrum. For the purpose of this document, we combine all these aspects into the abstraction A.

Typically, an access station A is permanently connected to the IP network, while connections between an access station A and terminals U are temporary in nature. For example, an access station A may be located in a public area (e.g. hotel, air-port, restaurant), or in a non-public area (e.g. in a private household). In the latter case, access can be limited to users who can obtain physical access (e.g. guests visiting the A's owner), or access may be available for all users in A's communication range (e.g. A may be a 802.11/Bluetooth/HiperLan base station in a private home which can be utilized to provide Internet access to A's neighbors and their visitors).

Internet Service Provider (P)

Prefers to an Internet Service Provider (ISP). An ISP provides services to terminal device U, based on a subscription arrangement between U and P that defines the service parameters. Hence, it can be assumed that P is responsible for billing U for the end-user service. In can also be assumed, that P has to pay A for using its resources. It is also P's responsibility to ensure that the traffic between U and its communication peers is secured against packet snooping/insertion/alteration or other attacks from A.

Typically, P is a company that provides individuals or other companies with Internet access and other related services, e.g. electronic mail, in order to generate revenue. Another possibility is that P is a company that provides its employees with access to an IP network, e.g. the corporate Intranet, the public Internet, or a private IP network. Here, the primary goal is not the immediate generation of revenue, but the support of the employee's work processes. For instance, a FedEx employee may occasionally access the corporate IP network to update the corporate database that he has delivered a shipment.

Trusted Network Element (T)

T refers to a trusted network element. T is a router inside the Internet that P deems trustworthy to the extent that T does not provide A with means to snoop/insert/alter traffic from or to the terminal device U. The present invention assumes that once the traffic reaches the Internet core, the traffic is reasonably safe against malicious attacks since, at this juncture, the network is only operated by a few, well established and trusted long-distance companies.

Different ISPs may apply different mechanisms and policies, probably depending on requirements of their users and U's current location in order to determine whether T is a trusted element. If P has no knowledge about trustworthy routers inside the Internet, it is assumed that P itself assumes the role of T, i.e. that P selects one of its own routers as T.

Remote Communication Peer (R)

R refers to a remote communication peer. A remote communication peer may be any remote host with whom the terminal U requests to communicate. For example, the remote communication peer R may include, but is not limited to, servers and other IP-based devices on the public Internet, servers on the corporate Intranet, or workstations or personal computers in a corporation's intranet or private IP network.

Assumptions

For the purpose of the present invention, it may be assumed that the components U and A, as well as A and P do not have a trusting relationship between one another. More specifically, when the terminal device U wants to communicate with a remote peer R, U will simply locate any access station A within its immediate vicinity in order to obtain service from P. Typically, U will have no long-lasting relationship with A that could result in trust between A and U.

Additionally, it may be assumed that the access station A does not trust U or P. The primary concern of the access station A is focused on obtaining reimbursement for the resources and services rendered to terminal U by the access station A.

Finally, P will not trust access station A. P has to ensure that its subscriber U is really using A's resources as claimed by A. This is to avoid a scenario wherein access station A reports a non existing terminal U to P, possibly even generating false traffic from U, where P would compensate A even though A is not serving any real subscriber of P. It is assumed that the payment procedures between P and A for services rendered by A to U are preferably governed by clearing agreements between the involved parties. As discussed above, the payment procedures between U and P are governed by the service agreement and may be based on a flat rate or a usage rate determined by either a unit of time and/or traffic volume.

Application of the Invention

In this discussion, it will be appreciated that the system and method for providing public access to an IP network (such as, for instance, the public Internet or a corporate intranet) via a third party owned infrastructure, may be implemented in a number of concrete ways as will be evident to one familiar with this field. In particular, the system and method described herein may be implemented entirely in hardware, software or a combination of both. Specifically, the access point, or any other hardware element utilized by the present invention, may include a processor and a memory under control of the processor. The memory may be provided with instructions (software) that are executed by the processor, and enable the processor to cause the access station, or other hardware, to perform in certain ways. Likewise, an access station could be implemented partly in hardware and software.

The disclosed system and method for providing access to the IP network may also be used in conjunction with wireless and wire-line access alike, where “wireless” may mean a short-range technology that operates in unlicensed frequency bands, as well a as larger range licensed radio technology.

Furthermore, the system for providing public access to the IP network may be implemented using either a wire-based, wireless or combination of means to connect to an IP network. Accordingly, it should be understood that the term “IP network” or “Internet” means “IP-based network” in its broadest sense, including but not limited to the public Internet, corporate intranets, private or public LANs, and IP-based ad-hoc networks.

The advantages of the disclosed system and mechanism for providing access to an IP network (such as the Internet) using a third party infrastructure are available for ISPs and to corporations that use the Internet for their communications needs. One advantage of the present invention is that the ISP/corporation does not need its own access network. Therefore, the ISP/corporation need not cover large areas with access points or obtain costly licenses for licensed frequency spectrum.

Exemplary applications of the system described herein include, but are not limited to the following cases:

Access stations in private households that provide wireless access to visitors and neighbors using wireless transmission standards including but not limited to WLAN (IEEE 802.11), BlueTooth (IEEE 802.15), or HiperLan;

Public area access stations implemented within network infrastructures owned and operated by third parties, such as hotels and airports, that provide customers and guests with Internet access that is controlled by the customer's ISP. The wireless standards for implementation may include but is not limited to WLAN (IEEE 802.11), BlueTooth (IEEE 802.15) and HiperLan; and

Access stations deployed and leased on a temporary basis. For example, conferences may lease access stations at conference venues, in order to give conference attendees Internet access that is controlled by the conference attendee's ISP. The wireless standards for implementation may include but is not limited to WLAN (IEEE 802.11), BlueTooth (IEEE 802.15) and HiperLan.

To accommodate a public access LAN environment with multiple wireless access technologies, a diverse set of wireless products and different types of wireless operators may coexist, it should thus be noted that embodiments of the invention are air interface independent and interoperable with wireless LAN cards from different vendors.

### Overview of the Invention

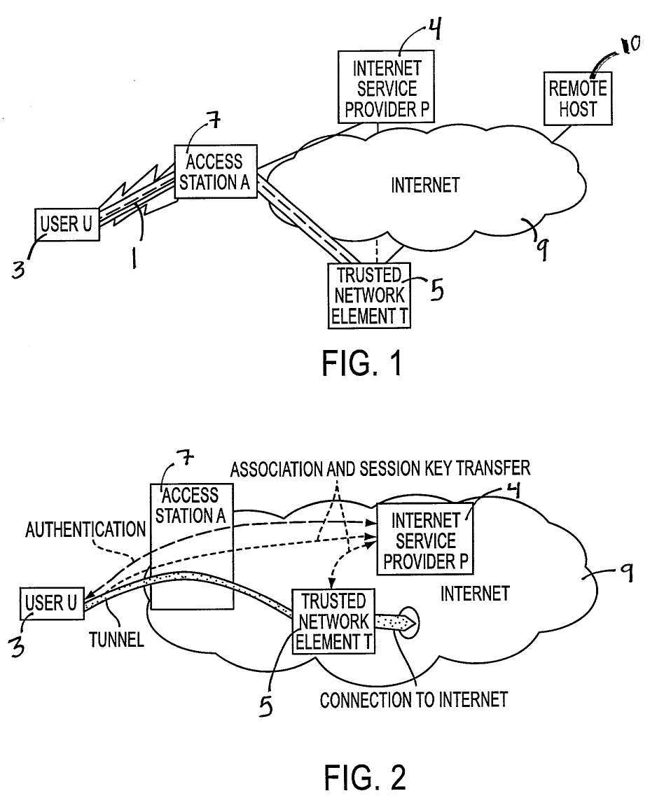

Referring now to FIG. 1, an illustration of a network capable of utilizing the components of the present invention and described above is illustrated. As depicted in FIG. 1, a secure tunnel (1) (represented by the dashed line) is established between terminal user U (3) and trusted node T (5) via access station A (7). Once terminal U (3) and ISP P (4) are authenticated, ISP P selects a trusted node T (5) and distributes session keys to terminal U (3) and trusted node (5) (represented by the dotted lines between the ISP (4), the terminal (3) and the trusted node T (5). This secret session key, which is not known to the access station A, is now being used to facilitate encryption between U and T. Together with the ability of access station A (7) to forward data from U to T and from T to U, a secure tunnel (1) between U and T can be established. Using the secure tunnel (1), terminal U (3) may transmit encrypted data packets to trusted node T (5). Trusted node T (5) forwards the data packet to the IP network (9) or more specifically to a remote host (11) as represented by the dashed line.

Referring now to FIG. 2, a similar network is depicted illustrating the authentication and session key transfer between terminal U (3), access station A (7), ISP P (4) and trusted node T (5) that is necessary for the establishment of a secure tunnel (1). Specifically, terminal U (3) and ISP P (4) send authentication challenges to one another via access station A (7) as depicted by the double arrow long dash line.. Upon the valid authentication of both terminal U (3) and ISP P (4), ISP P (4) generates and distributes session keys to a trusted node T (5) and terminal U (3) as depicted by the short dash line. Using the session key, terminal U (3) and trusted node T (5) encrypt and transfer data messages via the secure tunnel (1) which passes through access station A (7). However, due to the encryption of the data packet, access station A (7) is not able to decipher or modify the data packet. In other words, access station A (7) simply acts as a conduit between terminal U (3) and trusted node T (5) while trusted node T (5) forwards and receives data packets from the IP network (9).

Mutual Authentication of U and P

It is assumed that terminal U (3) arrives in switched-off mode at a location where it can gain access to access station A (7), i.e. terminal U (3) and access station A (7) are able to exchange data over the chosen communication media (wire-based or wireless). It is further assumed that terminal U (3) and ISP P (4) participate in a Public Key Infrastructure [PubKey]. Specifically, a participant in a public key infrastructure has two keys, a “public key” and a “private key”. The private key is only known to the participant and is never revealed to any other party. The public key is published so that everyone knows every participant's public key. For reasons that are explained in the reference “Applied Cryptography: Protocols, Algorithms, and Source Code in C,” which is incorporated herein, such keys have the property that data that is encrypted with one key (i.e. public or private) can be decrypted with the other key (i.e. private or public, respectively), but not with any other key.

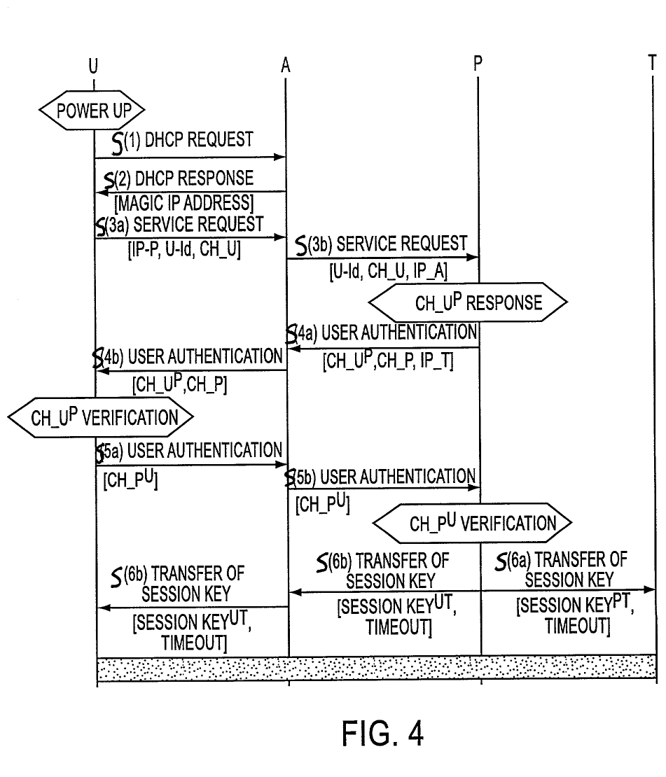

Referring now to FIGS. 2 and 4, a description of how a user terminal U (3) requests service from his ISP P (4), using an untrusted access station A (7), that happens to be in the vicinity of terminal U's (3) current location, is described.

In accordance with STEP S1, when terminal U (3) powers up and initializes its network interface, it broadcasts a dynamic host configuration protocol (“DHCP”) request to the network in order to obtain an IP address. If access station A (7) is in the range of this broadcast, it will receive this DHCP request. DHCP is an IP-based protocol that enables computers and workstations to get temporary or permanent IP addresses out of a pool that is administered by a central server. Typically, a host network runs the DHCP server while a workstation or mobile device runs the DHCP client. DHCP makes it possible to dynamically assign an IP address to a node (such as a mobile device) on the fly. For technical information and background concerning DHCP, R Drom's document entitled “Dynamic Host Configuration Protocol” is incorporated herein by reference. It is important to note that depending on the technology that terminal U (3) uses to communicate with access station A (7), it may be necessary for terminal U (3) create a form of association with access station (7) before terminal U (3) may broadcast a DHCP request. The procedures for establishing such an association are defined in the relevant documents relating to the IEEE 802.11 technology.

In accordance with STEP S2, if access station A (7) supports the mechanisms disclosed in this invention, access station A (7) replies to terminal U (3) with a “magic DHCP response”. A description of how terminal U (3) may differentiate between “magic” and “non-magic” (normal) DHCP responses will be described below. The purpose of the “magic DHCP response” is to indicate to terminal U (3) that the access station A (7) is compatible with the mechanisms described in this invention. If terminal U (3) receives a normal, i.e. non-magic DHCP response, terminal U (3) knows that those mechanisms described herein are not available because terminal U (3) will only obtained an IP-address according to the normal mode of operation of DHCP. In any case, the DHCP response contains the IP address of access station A (7) (identified as the gateway), as well as an IP address for terminal U (3) (identified as the client IP address).

DHCP response may be defined as a “magic DHCP response” in numerous ways, all of which are within the scope of the present invention. For example, a DHCP-response may qualify as a “magic DHCP response” if it contains an “AP DHCP-option field that is initialized to a value of “1”. The DHCP protocol allows for the dynamic introduction of new option fields. A new option field may be introduced, e.g. “AP”, which is not present in DHCP replies that are generated by nowadays DHCP servers. A value of 1 in the “AP” DHCP option field indicates that access station A (7), to which terminal U (3) is attempting to connect, supports the mechanism of the present invention. On the other hand, absence of an “AP DHCP option field or a value other than 1 indicates that access station A (7) does not support the mechanism of the present invention.

Alternatively, a “magic DHCP response” may be defined as a DHCP response that assigns a reserved IP address to terminal U. For example purposes only, the IP address 138.15.103.220, generally under administration of NEC USA, may be used for this purpose. Since this IP address is assigned to NEC USA, it can not be assigned to a DHCP client by any other network. NEC USA also guaranties that it will not use this address for any other purpose. Therefore, an assignment of IP address 138.15.103.220 to terminal U (3) indicates that access station A (7) supports the mechanisms of the present invention. On the other hand, assignment of an IP address other than 138.15.103.220 to terminal U (3) indicates that access station A (7) does not support the mechanism of the present invention.

If terminal U (3) simply receives a dynamically allocated IP address or “non-magic” DHCP response, terminal U (3) may be assured that the network and access station A (7) do not support the present invention. Therefore, terminal U (3) cannot obtain Internet access utilizing terminal U's (3) ISP P (4) via a third party owned, untrusted access station A (7).

In STEP S3a, as terminal U (3) knows about access station A's (7) existence and about the fact that access station A (7) supports the mechanisms of the present invention, it sends an identification packet to access station A (7), containing:

An IP address for the ISP with whom terminal U (3) is affiliated,

An identification string or number that was previously assigned to terminal U (3) by its affiliated ISP P (4), and

A challenge CH_U randomly generated by terminal U (3) in order to authenticate ISP P (4) as being the ISP with whom terminal U (3) is affiliated.

In STEP S3b, upon receiving the ISP authentication packet from terminal U (3), access station A (7) assigns a local unique identification (LUID) to terminal U (3). The LUID may be utilized by access station A (7) to associate or match messages and data packets with the correct terminal U (3) in situation where access station A (7) may be simultaneously serving multiple terminals U. The LUID may be any distinguishable identification attribute that will assist access station A (7) in transmitting data to the proper terminal U. By way of example and not limitation, the LUID may be terminal U's (3) MAC-address.

Access station A (7) then forwards a modified ISP authentication packet to ISP P (4). Access station A (7) knows the IP address of terminal U's ISP P (4), because it was included by terminal U (3) in the ISP identification packet that was sent from terminal U (3) to access station A (7) in step S3a. The modified ISP authentication packet includes:

Access station A's (7) IP address, so that ISP P (4) may forward data to access station A (7),

The LUID assigned to terminal U (3),

Terminal U's (3) identification number, and

Terminal U's (3) randomly generated challenge CH_U.

It should be clarified that terminal U's (3) identification number and terminal U's (3) LUID are two different and unrelated IDs. The identification number was assigned to terminal U (3) by ISP P (4) ahead of time (for instance, it could be a user name that was determined when terminal U (3) and ISP P (4) entered into the subscription agreement). On the other hand, the LUID is dynamically assigned to terminal U (3) by access station A (7), to be used exclusively by access station A (7) to enumerate the terminal U (3) for which access station A (7) is currently providing service. Neither terminal U (3), nor ISP P (4) have any influence on how access station A (7) chooses and assigns LUIDs.

In accordance with STEP S4a, upon receiving the modified ISP authentication packet from access station A (7), ISP P (4) is made aware of terminal U's (3) request to obtain Internet or other services via access station A (7). ISP P (4), however, cannot be certain that the originator of the ISP authentication packet is a valid terminal U (3) and thus affiliated with ISP P (4). Incidentally, the ISP authentication packet may have been sent from a user who does not have a subscription with ISP P (4). Alternatively, the access station (7) may be behaving maliciously by creating a request while pretending to be a user in order to obtain compensation from the ISP without having to render any service. Thus, ISP P (4) must authenticate the identity of terminal U (3) to ensure that terminal U (3) is a bon-a-fide subscribing customer of ISP P (4).

To authenticate terminal U (3), ISP P (4) generates a challenge CH_P that when properly answered by terminal U (3), will verify terminal U's (3) identity. It should be noted that such challenges are typically large numbers or strings generated by random number generators.

At this juncture ISP P (4) also responds to the challenge CH_U generated by terminal U (3) in step S3a. CH_U is simply encrypted with ISP P's (4) private key and sent to terminal U (3) so terminal U (3) may use ISP P's (4) public key to decrypt the message. It the original CH_U message is revealed then terminal U (3) is assured of ISP P's (4) authenticity (i.e. ISP P (4) is authenticated to terminal U (3)).

Additionally, ISP P (4) selects a trusted network node T (5), depending on terminal U's (3) security requirements and access station A's (7) location. Finally, ISP P (4) sends a packet with the following content to access station A (7):

ISP P's (4) response to terminal U's (3) challenge, which is CH_U encrypted with ISP P's (4) private key,

ISP P's (4) randomly generated challenge CH_P to authenticate terminal U (3),

The IP address of trusted node T (5),

The LUID that was assigned by access station A (7) to terminal U (3).

In STEP S4b, upon receiving the user authentication packet from ISP P (4), access station A (7) forwards a modified user authentication packet to terminal U (3). The modified user authentication packet contains:

ISP P's (4) response to terminal U's (3) challenge, which is CH_U encrypted with ISP P's (4) private key,

ISP P's (4) randomly generated challenge CH_P to authenticate user U (3), and

If access station A (7) is simultaneously serving multiple terminals, then the LUID assigned to terminal U (3) is also included in the user authentication packet.

As described above, the LUID helps access station A (7) determine which specific terminal U (3) should receive the data packet.

In STEP S5a, upon receiving the message from step S4b, terminal U (3) employs ISP P's (4) public key to decrypt and verify ISP P's (4) response to the challenge CH_U which was encrypted with by ISP P (4) with P's public key. If terminal U (3) is successfully able to decrypt ISP P's (4) response to the challenge CH_U using ISP P's (4) public key, then terminal U (3) may be assured that the encrypted response was actually generated by ISP P (4), thereby authenticating ISP P's (4)identity.

At this point, terminal U (3) also creates a response to the challenge CH_P generated by ISP P (4) to verify and authenticate terminal U's (3) identity. In response to ISP P's (4) challenge CH_P, terminal U (3) encrypts ISP P's (4) challenge CH_P with terminal U's (3) private key. Terminal U (3) then sends a message with the following content to access station A (7):

Terminal U's (3) response to ISP P's challenge CH_P.

In accordance with STEP S5b: access station A (7) receives the message from terminal U (3) that was generated in step S5a and forwards it to ISP P (4). It is not necessary but may be helpful if access station A (7) includes terminal U's (3) LUID in the message to ISP P (4). This would make it easier in the future for ISP P (4) to indicate the correct terminal U (3) to access station A (7) (for data that has to be sent from ISP P (4) to terminal U (3) via access station A (7)).

In STEP S6a and S6b: ISP P (4) verifies that terminal U's (3) response to the challenge CH_P was generated by a valid terminal U (3). In order to authenticate terminal U (3), ISP P (4) decrypts the response to the challenge CH_P with terminal U's (3) public key. If the decrypted response yields ISP P's (4) original challenge CH_P then ISP P (4) may be assured that terminal U (3) is a valid subscriber and thus affiliated with ISP P (4).

ISP P (4) now generates a session key that terminal U (3) and trusted node T (5) will later use for encrypting traffic between terminal U (3) and trusted node T (5), thus establishing a secure tunnel (1) between terminal U (3) and trusted node T (5). Along with the session key, a timeout value that determines the lifetime of the secure tunnel is conveyed to both, terminal U (3) and trusted node T (5).

The message generated in STEP S6a, which is sent from ISP P (4) to trusted node T (5), contains the following information:

A Session key^{PT}, which is the session key encrypted with trusted node T's (5) public key and ISP P P's (4) private key. It is important to note that because the session key is encrypted with trusted node T's (5) public key, only trusted node T (5) can decrypt it (using its private key). Because the session key is encrypted with ISP P's (4) private key, trusted node T (5) can verify that it actually comes from ISP P (4) (using ISP P's (4) well known public key);

A Timeout value that determines the lifetime of the secure tunnel (1) (as described further below);

The IP address of access station A (7); and

Terminal U's (3) LUID, as it was assigned to terminal U (3) by access station A (7).

The message generated in STEP S6b is sent from ISP P (4) to terminal U (3) via access station A (7), i.e. it is first sent from ISP P (4)to access station A (7), and then forwarded by access station A (7) to terminal U (3). The message contains the following information:

A session key^{UT}, which is the session key encrypted with terminal U's (3) public key and ISP P's (4) private key. It is important to note that because the session key is encrypted with terminal U's (3) public key, only terminal U (3) can decrypt it (using its private key). Because the session key is encrypted with ISP P's (4) private key, terminal U (3) can verify that it actually comes from ISP P (4) (using ISP P's (4) well known public key);

A Timeout value that determines the lifetime of the secure tunnel (1); and

Terminal U's (3) LUID, as it was assigned to terminal U (3) by access station A (7). It is important to note that the: LUID is only needed by access station A (7) to forward the message to the correct terminal U (3). This information field can optionally be omitted in the final message that is sent from access station A (7) to terminal U (3)).

Creation of a Secure Tunnel (1) between Terminal U (3) and Trusted Node T (5), via Access Station A (7)

Once terminal U (3) and ISP P (4) have been authenticated, terminal U (3) can send IP packets to access station A (7), which access station A (7) can forward to trusted node T (5), and vice versa (trusted node T (5) can send IP packets to access station A (7), which access station A (7) can then forward to terminal U (3)). As a result, a secure tunnel (1) between terminal U (3) and trusted node T (5) (via access station A (7)) is established. The purpose of this secure tunnel (1) is to emulate a physical link between terminal U (3) and trusted node T (5). Moreover, since terminal U (3) and trusted node T (5) are both in possession of the same secret session key (which was generated by ISP P (4)), traffic through the secure tunnel (1) may be encrypted with this session key. Encrypting the packets that pass through the secure tunnel makes it impossible for the network elements located between terminal U (3) and trusted node T (5) (such as access station A (7)) to add, modify or remove the IP packets without being detected by terminal U (3) or trusted node T (5).

When access station A (7) sends messages to trusted node T (5), it will always include the LUID of the terminal U (3) which originated the message. The LUID together with access station A's (7) IP-address create a globally unique ID that can be used by trusted node T (5) to identify terminal U (3).

Moreover, trusted node T (5) will include the same LUID into messages that it sends to access station A (7) (for final delivery to terminal U (3)).Access station A (7) can use the LUID to determine the correct terminal U (3) to which the message has to be forwarded. Since the LUID is not of relevance to terminal U (3), access station A (7) may optionally remove it from message that it forwards from trusted node T (5) to terminal U (3).

Data Transfer between Terminal U and the IP Network

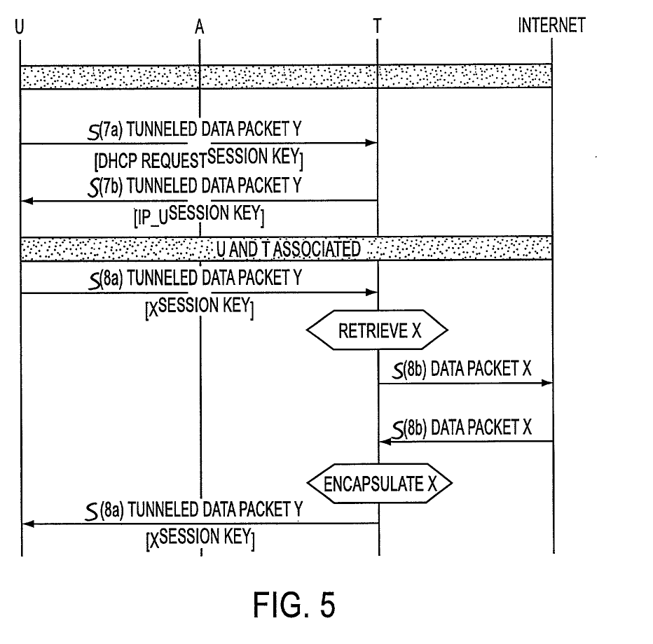

Referring now to FIGS. 2 and 5, the data transfer between terminal U (3) and the IP network (9)(such as the Internet or corporate intranet) is depicted. As opposed to FIG. 4 which depicted the message sequence between terminal U (3), access station A (7), ISP P (4), and trusted node T (5), it is important to note that FIG. 5 illustrates the message sequence between terminal U (3), access station A (7), trusted node T (5) and the Internet (9).

As seen in FIG. 5 and explained above, a secure tunnel (1) is established for transmitting data between terminal U (3) and trusted network T (5) via access station A (7). The capability of terminal U (3), access station A (7), and trusted node T (5) to exchange IP packets through the secure tunnel (1) makes further involvement of ISP P (4) unnecessary (ISP P's (4) involvement ends when the generated session key has been securely distributed to terminal U (3) and trusted node T (5)).

In general, prior to sending IP packets through the secure tunnel (1), terminal U (3) forwards a second DHCP request to trusted node T (5) via the secure tunnel (1) in order to obtain an IP address from trusted node T (5). It is important to note that the secure tunnel (1) emulates a physical link between terminal U (3) and the trusted node T (5). Once the secure tunnel (1) is established, terminal U (3) has two network interfaces (each of which needs an IP address):

(1) The physical interface (e.g. an Ethernet card or an 802.11 wireless LAN card) which connects terminal U (3) with access station A (7). Terminal U (3) obtained an IP address for this interface by sending out the first DHCP request. This DHCP request was received by and replied to by access station A (7).

(2) The logical interface to the secure tunnel (1), which connects terminal U (3) with trusted node T (5). Terminal U (3) has to obtain another IP address for this interface by broadcasting a second DHCP request through the secure tunnel (1).

However, this second DHCP request is received by and replied to by trusted node T (5).

By obtaining the second IP address from trusted node T (5), terminal U (3) may now generate IP packets with a source address that is routed by the global Internet (9) to trusted node T (5). Additionally, trusted node T (5) may now forward IP packets with that destination address to terminal U (3) through the tunnel between trusted node T (5) and terminal U (3).

A description of the mechanisms related to the second DHCP request is herein provided. Terminal U (3) generates a second DHCP request in order to make the secure tunnel (1), which it established between itself (terminal U (3)) and trusted node T (5), available as an additional (logical) network interface. As depicted in STEP S7a, terminal U (3) encrypts the DHCP request with the session key that is shared between terminal U (3) and trusted node (5). Terminal U (3) then places the encrypted DHCP request into the payload field of a new IP packet “Y.” (ie: Y[DCHP-request/session_key]). The “Y” IP packet has the IP address of trusted node T (5) as its destination address and the IP address of access station A (7) as its source address. The “Y” IP packet (Y[DHCP-request/session_key]) is forwarded to access station A (7). Access station A (7) forwards the “Y” IP packet to trusted node T (5) but is unable to decipher the contents within the packet since access station A (7) is not in possession of the proper session key. It is important to note that access station A (7) may add terminal U's (3) LUID to the “Y” IP packet when forwarding the packet to trusted node T (5) as was described above.

In accordance with STEP S7b, upon receiving the “Y” IP packet from terminal U (3) via access station A (7) that contains the encrypted DHCP request, trusted node T (5) recovers the DHCP-request, allocates an IP-address to terminal U (3) and generate a DHCP-response for terminal U (3). It should be clear that the IP address that is assigned to terminal U (3) by this DHCP response is the IP address that the global Internet (9) uses to route messages to trusted node T (5). The DHCP-response may then be encrypted with the session key and forwarded to access station A (7) which sends the response to terminal U (3). All the while access station A (7) is unable to decipher the contents of the reply.

Upon receiving the encrypted DHCP response, terminal U (3) is in possession of an IP-address that the global Internet (9) routes to trusted node T (5), and which trusted node T (5) will forward to terminal U (3) (through the secure tunnel (1), via access station A (7)). For clarity it should be noted that the IP address that is contained in the mentioned DHCP response is not the IP address of trusted node T (5) itself, but rather an IP address that the global Internet (9) routes to trusted node T (5). When trusted node T (5) receives a message with this IP address as its destination address, trusted node T (5) can easily determine that trusted node T (5) is not the final receiver of the message, but that it is rather supposed to forward the message towards its formal destination which is terminal U (3) (i.e. trusted node T (5) acts as a router). When trusted node T (5) responds to terminal U's (3) DHCP request with a DHCP response that contains said IP address, it will keep a record that associates said IP address with terminal U's (3) identity and with the corresponding access station A (7). This information allows trusted node T (5) to determine the following information for every IP packet that it receives from the global Internet (9):

The associated terminal U (3) to which the packet should be forwarded.

The secure tunnel (1) that connects trusted node T (5) with that particular terminal U (3).

The session key that has to be used for encrypting the packet for transmission through the secure tunnel (1).

The associated access station A (7) through which the secure tunnel (1) runs and to which the encrypted packet has to be forwarded.

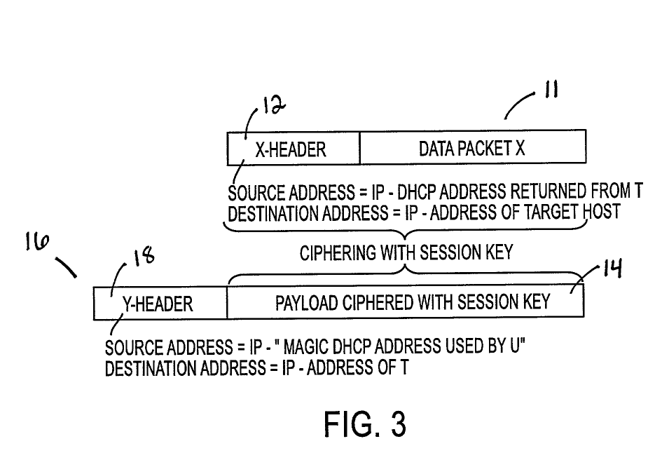

In accordance with STEP S8a, the transmission of packet traffic between terminal U (3) and trusted node T (5) (via the secure tunnel (1)) is described in detail. This description is supplement by reference to FIG. 3 which shows a detailed breakdown of the data packet. Specifically, terminal U (3) creates a new IP packet X (11). As seen in FIG. 3, the packet header (12), for data packet X (11), has a destination address of a remote host R (10) (as shown in FIGS. 1 and 2) and a source address from terminal U (3). Specifically, the source address is the DHCP IP address returned from trusted node T (5) to terminal U (3) upon terminal U's (3) request.

The entire IP packet (11) (includes data packet X and header) is then encrypted with the session key that is shared between terminal U (3) and trusted node T (5) and stored as payload (14) with the data packet Y (16) (e.g, Y[X/key]). Thus, the header (18) destination address for the encrypted IP packet Y[X/key] (16) is the IP address of trusted node T (5) while the source address of the IP packet is the magic DHCP address assigned to terminal U (3).

As depicted in STEP S8a, access station A (7) receives the encrypted IP-packet Y[X/key] (16). Access station A (7), of course, is not able to recover or manipulate the contents (i.e. X) contained within the encrypted IP packet Y[X/key] (16). Therefore, access station A (7) forwards the encrypted IP packet Y[X/key] (16) to trusted node T (5) by replacing the source-address field in the encrypted IP packet Y[X/key] (16) with access station A's (7) IP address thus creating a modified packet Y′[X/key]. Additionally, access station A (7) may add terminal U's (3) LUID to the modified IP packet Y′[X/key] in order to help trusted node T (5) to determine which terminal U (3) sent the original packet X (11) . Trusted node T (5) has to know which terminal U (3) sent the packet (11) in order to choose the correct session key for deciphering the message.

In accordance with STEP S8b, trusted node T (5) recovers the original data packet X (11). The data packet X (11) is forwarded to the Internet (9). Similarly, any data packets destined for terminal U (3) from the Internet (9) are received by trusted node T (5) as depicted in STEP S8b. Trusted node T (5) encrypts the data packet using the session key and then forwards the encrypted packet to access station A (7) as depicted in STEP S8a. Access station A (7) then forwards the message to the correct terminal U (3) based on the LUID.

Alternatively, STEP S7 may be omitted if a Network Address Translation mechanism (NAT) that maps a unique duple IP source address and Port source number to the tunnel is employed. Thus, the first data packet X (11) that is sent by terminal U (3) and received by trusted node T (5) will associate terminal U (3) with trusted node T (5). Therefore, a data structure that maps the connection parameters between the tunnel and external Internet connection is instantiated.

Tunnel Release, Timeout

A timeout mechanism triggers the release of resources that are associated with the secure tunnel (1) established between terminal U (3) and trusted node T (5). Said resources are located at terminal U (3), access station A (7) and trusted node T (5). Timing mechanisms that control the timeout and tunnel release may be located at both ends of the tunnel. (i.e. within terminal U (3) and within trusted node T (5)). The timing mechanism is set upon successful delivery of the session key to terminal U (3) and trusted node T (5). The timer values for each respective timing mechanism may be passed along with the session key transferred between ISP P (4) and terminal U (3), and ISP P (4) and trusted node T (5).

A separate timer that controls the service provisioning to terminal U (3) and the associated resources provided is maintained in access station A (7). The timer is started once the tunnel (l)is established, i.e. the session key is transferred. Preferably, the timeout value destined for terminal U (3) can be used as a preset value for the timer. Services provisioning are stopped and resources at access station A (7) are released upon timeout. To ensure proper operation, even in case of data transfer the timeout value of the timer located in access station A (7) should be greater than the timeout value of the tunnel (1) timeout.

To extend the lifetime of the tunnel (1), terminal U (3) may invoke a new service and re-authentication requests with ISP P (4) before the timer expires. The re-authentication request ensures the authenticity of terminal U (3) and the metered duration information for the connection service provided by access station A (7) to terminal U (3). Once the timers at terminal U (3) and trusted node T (5) expire, tunnel resources are freed from the respective network elements.

Each timer, however, is associated with a safety time margin to ensure proper operation and maintenance of a tunnel during slow data transfer. The safety time margin allocates a buffer of additional time to the timers thus allowing slow data transfers to be completed before the resources are released or a re-authentication request is made.

Billing

An accounting method based on the amount of time access station A (7) provides services to terminal U (3) is also provided. A metered unit is utilized to account for the time period that access station A (7) provides services to terminal U (3). The metered unit is determined by the timeout value passed to terminal U (3), trusted node T (5) and access station A (7). The metered unit may be a time unit ranging from multiple of tens of seconds to multiple of minutes. Typically, a metered unit is defined by the service agreement between ISP P (4) and access station A (7) as well as the agreement between ISP P (4) and terminal U (3). The timeout value may be affected by time granularity and the signaling and processing overhead caused by the invocation of re-authentication procedures. Since a timing mechanism is required for the proper operation of the system, billing information can be derived from the timeout values conveyed during the periodic re-authentication procedure.

Although timer values may be generated and distributed by ISP P (4) such that ISP P (4) compensates access station A (7) for resources utilized by terminal U (3) and bills terminal U (3) based on timer values, terminal U (3) may also obtain ISP service through prepaid option. For example, terminal U (3) may have a pre-paid subscription with ISP P (4) that allows terminal U (3) to access and utilize resources provided by access station A (7)for a given time period t. Time period t corresponds to the amount of metered units (e.g. minutes) purchased from ISP P (4) by terminal U (3). Typically, each successful authentication and re-authentication results in a decrement of monetary equivalent for the timeout interval (e.g. a minute). Once the pre-paid time units are depleted, ISP P (4) will not re-authenticate or distribute new timeout values to terminal U (3). Subsequently, timers at access station A (7), trusted node T (5) and terminal U (3) will expire and the tunnel (1) with its associated resources will be released.

What is claimed is:

1. A method for performing mutual authentication and authorization of a user's terminal device (U) and an Internet Service Provider (P) in order to establish secure communication between the terminal (U) and a trusted gateway (T) to the Internet via an untrusted access station (A) comprising:
establishing an association between a terminal (U) and an untrusted access station (A);
transmitting an ISP authentication packet from terminal (U) to ISP (P) via the untrusted access station (A);
sending a user authentication packet from said ISP (P) to said terminal (U) via said untrusted access station (A);
upon authentication of said terminal (U) and said ISP (P), said ISP performs the following:
generating a session key;
distributing said session key to said terminal (U) and a trusted gateway (T), wherein said session key is used to encrypt traffic between the terminal (U) and the trusted gateway (T);
establishing a secure tunnel such that the terminal (U) may communicate with the Internet via said trusted gateway (T);
wherein said secure tunnel emulates a physical link between the terminal (U) and the trusted gateway (T) such that traffic transmitted between the terminal (U) and said Internet via said trusted gateway (T) is secure from modification or eavesdropping by said third party access station (A).

2. The method for performing mutual authentication and authorization of a terminal (U) and an Internet Service Provider (P) in order to establish a secure tunnel between the terminal (U) and a trusted gateway to the Internet (T) via an untrusted access station (A) of claim 1, wherein the ISP (P) authentication packet contains an authentication challenge (CH_U) from terminal (U) to ISP (P) to authenticate the identity of ISP (P).

3. The method for performing mutual authentication and authorization of a terminal (U) and an Internet Service Provider (P) in order to establish a secure tunnel between the terminal (U) and a trusted gateway to the Internet (T) via an untrusted access station (A) of claim 1, wherein the user authentication packet contains an authentication challenge (CH_P) from ISP (P) to the terminal (U) to authenticate the identity of user (U).

4. A method for providing public access to IP-based networks via an untrusted infrastructure having untrusted access points comprising:
establishing a connection between an IP-device (U) and said untrusted access point (A), wherein an IP address is dynamically allocated to said IP device;
transmitting an ISP authentication request from said IP device (U) to an internet service provider (P) affiliated with said IP device (U), wherein said authentication request is transmitted through said untrusted access point (A) affiliated with said untrusted third party owned infrastructure;
transmitting a user authentication request from said ISP (P) to said IP device (U) to determine whether said IP device (U) is a valid user affiliated with said ISP (P), wherein said authentication request is transmitted through said untrusted access point (A) affiliated with said untrusted third party owned infrastructure;
when said ISP (P) authentication request and said user authentication requests is affirmative, said ISP (P):
generates a key session for encrypting data packets; and
distributes said session key to said IP device (U) and a trusted node (T), wherein said session key is used to encrypt data transmitted between said IP device (U) and said trusted node (T);
establishing a secure tunnel as said session key is used to encrypt data packets transmitted between said IP device (U) and said trusted node (T), such that said data packets transmitted between said IP device (U) and an Internet via the untrusted access station (A) are protected from modification and manipulation by said untrusted access station (A) in said secure tunnel.

5. A method for providing public access to IP-based networks through a third party owned, untrusted infrastructure having untrusted access stations (A) comprising:
establishing a connection between an IP-device (U) and said access station (A), wherein an IP address is dynamically allocated to said IP device (U);
sending an ISP authentication request to said internet service provider (P) affiliated with said IP device (U) requesting to validate the authenticity of the ISP (P);
sending a user authentication request from said ISP (P) to said IP device (U) to validate whether said IP device (U) has a service agreement with said ISP (P);
upon affirmative authentication of said ISP (P) and said IP device (U);
establishing a trusted connection between said IP device (U) and a trusted gateway (T), wherein a secure tunnel allows the ISP (P) to dynamically obtain control of resource in said untrusted third party owned access station (A) in order to provide the IP device (U) with prescribed for services.

6. A method of establishing secure communication between a terminal (U), the Internet Service Provider (P) affiliated with that terminal and the Internet over a third party owned untrusted access station (A) comprising:
establishing a connection between the terminal (U) and said access station (A);
sending an ISP authentication request to said internet service provider (P) affiliated with said terminal (U);
sending a user authentication request from said ISP (P) to said terminal (U);
upon affirmative authentication of said ISP (P) and said terminal (U):
establishing a trusted connection between said IP device (U) and a trusted gateway (T), wherein a secure tunnel allows the ISP (P) to dynamically obtain control of resource in said untrusted access station (A) in order to provide the IP device (U) with prescribed for services.

7. A method of establishing secure communication between a terminal (U), the Internet Service Provider (P) affiliated with that terminal and the Internet over an untrusted access station (A) of claim 6, wherein the ISP authentication request contains an authentication challenge (CH_U) from terminal (U) to ISP (P) to authenticate the identity of ISP (P).

8. A method of establishing secure communication between a terminal (U), the Internet Service Provider (P) affiliated with that terminal and the Internet over an untrusted access station (A) of claim 6, wherein the user authentication request contains an authentication challenge (CH_IP) from ISP (P) to the terminal (U) to authenticate the identity of terminal (U) as having subscribed to said ISP (P) for services.

9. A method of establishing secure communication between a terminal (U), the Internet Service Provider (P) affiliated with that terminal and the Internet over an untrusted access station (A) of claim 6, the ISP (P) generates a session key for encrypting data packets upon the affirmative authentication of the terminal (U) and the ISP (P).

10. A method of establishing secure communication between a terminal (U), the Internet Service Provider (P) affiliated with that terminal and the Internet over an untrusted access station (A) of claim 6, wherein the ISP (P) selects a trusted node (T) with said Internet.

11. A method of establishing secure communication between a terminal (U), the Internet Service Provider (P) affiliated with that terminal and the Internet over an untrusted access station (A) of claim 9, wherein said ISP (P) distributes said session key to the terminal (U) and the trusted node (T).

12. A method of establishing secure communication between a terminal (U), the Internet Service Provider (P) affiliated with that terminal and the Internet over an untrusted access station (A) of claim 6, wherein the session key is used to encrypt data packets transmitted between the terminal (U) and the trusted node (T).

13. A method of establishing secure communication between a terminal (U), the Internet Service Provider (P) affiliated with that terminal and the Internet over an untrusted access station (A) of claim 12, wherein the transmission of encrypted data packets between the terminal (U) and the trusted node (T) established a secure tunnel.

14. A method of establishing secure communication between a terminal (U), the Internet Service Provider (P) affiliated with that terminal and the Internet over an untrusted access station (A) of claim 13, wherein the secure tunnel protects the data packets from manipulation by said untrusted access station (A).

15. A method of establishing secure communication between a terminal (U), the Internet Service Provider (P) affiliated with that terminal and the Internet over an untrusted access station (A) of claim 6, a time out is distributed to the trusted node (T) and terminal (U) upon the establishment of a secure tunnel.

16. A method of establishing secure communication between a terminal (U), the Internet Service Provider (P) affiliated with that terminal and the Internet over an untrusted access station (A) of claim 15, wherein the timeout value is set to a predetermined time period, wherein if the secure tunnel is active for a time period equal to the timeout value, the secure tunnel will expire and the resources utilized for the secure tunnel will be releases.

17. A method of establishing secure communication between a terminal (U), the Internet Service Provider (P) affiliated with that terminal and the Internet over an untrusted access station (A) of claim 6, wherein upon receipt of an encrypted data packet from the terminal (U), the trusted node (T) decrypts the data packet and forwards the decrypted data packet to the Internet.

18. A method of establishing secure communication between a terminal (U), the Internet Service Provider (P) affiliated with that terminal and the Internet over an untrusted access station (A) of claim 17, wherein upon receipt of an encrypted data packet from the terminal (U), the trusted node (T) decrypts the data packet and forwards the decrypted data packet to a remote communication peer (R).

19. A method of establishing secure communication between a terminal (U), the Internet Service Provider (P) affiliated with that terminal and the Internet over an untrusted access station (A) of claim 18, wherein the Internet sends an original data packet to the terminal (U) via the trusted node (T), wherein the trusted node (T) encrypts the original data packet and forwards the encrypted data packet to the terminal (U) via the untrusted access station (A).

20. A method of establishing secure communication between a terminal (U), the Internet Service Provider (P) affiliated with that terminal and the Internet over an untrusted access station (A) of claim 17, wherein upon receipt of the encrypted data packet from the trusted node (T), the terminal (U) utilizes the session key to decrypt the data packet thus yielding the original data packet from the Internet.

21. A method of establishing secure communication between a terminal (U), the Internet Service Provider (P) affiliated with that terminal and the Internet over an untrusted access station (A) of claim 18, wherein a remote communication peer (R) sends an original data packet to the terminal (U) via the trusted node (T), wherein the trusted node (T) encrypts the original data packet and forwards the encrypted data packet to the terminal (U) via the untrusted access station (A).

22. A method of establishing secure communication between a terminal (U), the Internet Service Provider (P) affiliated with that terminal and the Internet over an untrusted access station (A) of claim 21, wherein upon receipt of the encrypted data packet from the trusted node (T), the terminal (U) utilizes the session key to decrypt the data packet thus yielding the original data packet from the remote communication peer (R).

23. A method of establishing secure communication between a terminal (U), the Internet Service Provider (P) affiliated with that terminal and the Internet over an untrusted access station (A) of claim 6, wherein the ISP (P) provides an accounting of time to the untrusted access station (A) for resources utilized by the terminal (U).

24. A method of establishing secure communication between a terminal (U), the Internet Service Provider (P) affiliated with that terminal and the Internet over an untrusted access station (A) of claim 6, wherein the untrusted access station (A) is incorporated into a third party owned network infrastructure.

25. A method of establishing secure communication between a terminal (U), the Internet Service Provider (P) affiliated with that terminal and the Internet over an untrusted access station (A) of claim 24, wherein the ISP (P) provides the terminal (U) with at least one subscribed for service via an untrusted access station (A).

26. A method of establishing secure communication between a terminal (U), the Internet Service Provider (P) affiliated with that terminal and the Internet over an untrusted access station (A) of claim 6, wherein the ISP (P) reimburses the untrusted access station (A) for resources expended on the terminal (U) according to an accounting of time.

27. A method of establishing secure communication between a terminal (U), the Internet Service Provider (P) affiliated with that terminal and the Internet over an untrusted access station (A) of claim 25, wherein the ISP (P) bills the terminal (U) for services provided to the terminal (U).

28. A method of establishing secure communication between a terminal (U), the Internet Service Provider (P) affiliated with that terminal and the Internet over an untrusted access station (A) of claim 24, wherein the untrusted access station (A) is located in the network infrastructure of a public facility.

29. A method of establishing secure communication between a terminal (U), the Internet Service Provider (P) affiliated with that terminal and the Internet over an untrusted access station (A) of claim 28, wherein the public facility is at least one of an airport, a convention center, a restaurant, a hotel, a library, and a school.

30. A method of establishing secure communication between a terminal (U), the Internet Service Provider (P) affiliated with that terminal and the Internet over an untrusted access station (A) of claim 24, wherein the untrusted access station (A) is located within the infrastructure of a private household or within the private infrastructure of a corporation or government institution.

31. A method of establishing secure communication between a terminal (U), the Internet Service Provider (P) affiliated with that terminal and the Internet over an untrusted access station (A) of claim 6, wherein the untrusted access stations (A) is compatible with at least one wireless transmission standard including WLAN (IEEE 802.11), BlueTooth (IEEE 802.15), or HiperLan.

32. A method of establishing secure communication between a terminal (U), the Internet Service Provider (P) affiliated with that terminal and the Internet over an untrusted access station (A) of claim 32, wherein the terminal (U) is a mobile device.

33. A method of establishing secure communication between a terminal (U), the Internet Service Provider (P) affiliated with that terminal and the Internet over an untrusted access station (A) of claim 6, wherein the terminal (U) recognizes a compatible access point by broadcasting a dynamic host configuration protocol (DHCP) request and receiving a “magic” DHCP response from the untrusted access station (A).

34. A method of establishing secure communication between a terminal (U), the Internet Service Provider (P) affiliated with that terminal and the Internet over an untrusted access station (A) of claim 6, wherein the untrusted access station (A) assigns an local unique identification (LUID) to the terminal (U) in order to facilitate matching the terminal with data packets when the untrusted access station (A) is simultaneously serving multiple terminals (U).

35. A computer program product for accessing and authenticating Internet service via an untrusted access point comprising:
software instructions for enabling the computer to perform predetermined operations, and a computer readable medium bearing the software instructions;
the predetermined operations including establishing a connection between an IP-device (U) and said access station (A), wherein an IP address is dynamically allocated to said IP device (U);
sending an ISP authentication request to said internet service provider (P) affiliated with said IP device (U) requesting to validate the authenticity of the ISP (P);
sending a user authentication request from said ISP (P) to said IP device (U) to validate whether said IP device (U) has a service agreement with said ISP (P);
upon affirmative authentication of said ISP (P) and said IP device (U). establishing a trusted connection between said IP device (U) and a trusted gateway (T), wherein a secure tunnel allows the ISP (P) to dynamically obtain control of resource in said untrusted third party owned access station (A) in order to provide the IP device (U) with prescribed for services.
